(19) United States
(12) Patent Application Publication
(10) Pub. No.: US 2026/0234419 A1
(43) Pub. Date: Aug. 13, 2026

(54) Two-Component Magnetic Coating Composition System for Reversible Attachment of Thin Materials

(71) Applicant: Ainura Ashirakhmanova, Mount Prospect, IL (US)

(72) Inventor: Ainura Ashirakhmanova, Mount Prospect, IL (US)

(21) Appl. No.: 19/538,980

(22) Filed: Feb. 13, 2026

Related U.S. Application Data
(60) Provisional application No. 63/757,787, filed on Feb. 12, 2025.

(51) Int. Cl. C09D 5/23

(52) U.S. Cl. CPC C09D 5/23

(57) ABSTRACT

A two-component magnetic coating composition system for reversible attachment of thin materials. A first coating composition contains magnetically responsive particles capable of being attracted to a magnetic field. A second coating composition contains magnetic particles capable of generating a magnetic field after forming a dried or set layer. When the first and second coating compositions are applied to separate substrates and allowed to dry or set, the coated surfaces magnetically attract one another and form a temporary connection. The connection may be repeatedly separated and reattached without adhesives or mechanical fasteners and without substantial loss of attachment functionality.

### CROSS-REFERENCE TO RELATED APPLICATIONS

This application claims priority to U.S. Provisional Patent Application No. 63/757,787, filed on Feb. 12, 2025, the entirety of which is incorporated herein by reference.

### FIELD OF THE INVENTION

The present invention relates to temporary fastening systems and, more specifically, to a two-component magnetic coating composition system enabling repeated reversible attachment of thin materials without adhesives or mechanical fasteners.

### BACKGROUND OF THE INVENTION

Temporary attachment of paper, cardboard, and similar thin materials traditionally relies on adhesives, tapes, clips, staples, or mechanical fastening elements. These methods may leave residue, damage surfaces, increase thickness, reduce flexibility, and limit reusability. Magnetic attachment systems typically require solid magnets or magnetic sheets, which increase thickness and are not well suited for thin flexible substrates. There exists a need for a liquid-applied magnetic system that enables reversible, reusable attachment of thin materials while preserving substrate flexibility and structural integrity.

### SUMMARY OF THE INVENTION

The invention provides a two-component coating composition system comprising: Component A: a coating composition containing magnetically responsive particles capable of being attracted by a magnetic field; and Component B: a coating composition containing magnetic particles capable of generating a magnetic field after application and formation of a dried or set layer.

When applied separately to two substrates and allowed to form a dried or set coating layer, the treated surfaces become magnetically interactive. Upon contact, the treated surfaces attract one another and form a temporary connection that may be repeatedly separated and reattached without substantial degradation.

The coating compositions may be provided in the form of a lacquer, paint, gel, suspension, ink, paste, polymer composition, curable resin, or any other applicable liquid or flowable coating medium.

### DETAILED DESCRIPTION OF THE INVENTION

The system includes two separate coating compositions. Component A contains dispersed magnetically responsive particles. Component B contains dispersed magnetic particles capable of generating a magnetic field after drying or setting. The compositions may be packaged separately and supplied as a coordinated kit.

The method of use includes: (1) applying Component A to a first substrate; (2) applying Component B to a second substrate; (3) allowing the coatings to dry or set; and (4) bringing the treated surfaces into proximity to form a reversible magnetic attachment.

Suitable substrates include paper, cardboard, fabric, thin plastic sheets, and other flexible or thin materials. The dried coatings remain sufficiently thin so as not to substantially interfere with the natural bending characteristics of the substrate.

What is claimed is:

1. A method for creating a reversible magnetic connection between two substrates, comprising:
applying a first coating composition containing magnetically responsive particles to a first substrate;
applying a second coating composition containing magnetic particles to a second substrate;
allowing the first and second coating compositions to form dried or set layers; and
bringing the first and second substrates into proximity, whereby magnetic attraction between the dried or set layers forms a temporary connection between the substrates.

2. The method of claim 1, wherein the first and second substrates are flexible materials.

3. The method of claim 1, wherein the temporary connection may be repeatedly formed and separated without substantial loss of magnetic attachment functionality.

4. The method of claim 1, wherein the first coating composition is in the form of a lacquer, paint, gel, suspension, ink, paste, polymer composition, or curable resin.

5. The method of claim 1, wherein the second coating composition is in the form of a lacquer, paint, gel, suspension, ink, paste, polymer composition, or curable resin.

6. A two-component system for reversible magnetic attachment, comprising:
a first coating composition containing magnetically responsive particles capable of being attracted to a magnetic field; and
a second coating composition containing magnetic particles capable of generating a magnetic field after forming a dried or set layer;
wherein the first and second coating compositions are configured to create a reversible magnetic attachment when applied to separate substrates and allowed to dry or set.

7. The system of claim 6, wherein the first and second coating compositions are each independently selected from the group consisting of a lacquer, paint, gel, suspension, ink, paste, polymer composition, and curable resin.

8. A kit for reversible magnetic attachment of substrates, comprising:
a first container containing a first coating composition comprising magnetically responsive particles; and
a second container containing a second coating composition comprising magnetic particles capable of generating a magnetic field after forming a dried or set layer.

9. The kit of claim 8, further comprising instructions for applying the first coating composition to a first substrate and applying the second coating composition to a second substrate to form a reversible magnetic attachment upon contact of the coated surfaces.
